(19) United States
(12) Patent Application Publication
(10) Pub. No.: US 2010/0309587 A1
(43) Pub. Date: Dec. 9, 2010

(54) FLUID DYNAMIC BEARING, SPINDLE MOTOR HAVING THE FLUID DYNAMIC BEARING, AND STORAGE APPARATUS HAVING THE SPINDLE MOTOR

(75) Inventor: Weihong YANG, NAGANO (JP)

Correspondence Address: CARRIER BLACKMAN AND ASSOCIATES, 43440 WEST TEN MILE ROAD, EATON CENTER, NOVI, MI, 48375, US

(73) Assignee: MINEBEA CO., LTD., KITASAKU-GUN (JP)

(21) Appl. No.: 12/793,104

(22) Filed: Jun. 3, 2010

(30) Foreign Application Priority Data
Jun. 5, 2009 (JP) 2009-135891

(51) Int. Cl. G11B 5/48; F16C 32/06; H02K 7/08; H02K 5/16

(52) U.S. Cl. 360/240; 384/107; 310/90; 310/89; G9B/5.147

(57) ABSTRACT

A fluid dynamic bearing is configured that a distance L1 from an annular region of a cover member along a direction of an axis of rotation to a first thrust bearing surface of a radial bearing member, and a distance L2 from a stopper surface of a stopper portion to a second thrust bearing surface of a thrust bearing member, satisfy the following relationship: L1<L2, wherein the annular region of the cover member is in contact with the stopper surface of the stopper portion, and the first thrust bearing surface of the radial bearing member is separated from the second thrust bearing surface of the thrust bearing member to form a gap being filled with a lubricant fluid when the radial bearing member is in non-rotating state with respect to a stationary shaft.

### CROSS-REFERENCE TO THE RELATED APPLICATION(S)

The present disclosure relates to the subject matters contained in Japanese Patent Application No. 2009-135891 filed on Jun. 5, 2009, which are incorporated herein by reference in its entirety.

### BACKGROUND

1. Field

The present invention relates to a fluid dynamic bearing for rotating recording disks, such as a magnetic disk and an optical disc, a spindle motor provided with the fluid dynamic bearing, and a storage apparatus provided with the spindle motor.

2. Description of the Related Art

The storage apparatus has the spindle motor that uses the fluid dynamic bearing to rotate a recording disk. The fluid dynamic bearing has a thrust dynamic pressure bearing portion and a radial dynamic pressure bearing portion, which are provided between a rotating member and a stationary member of the spindle motor so that a micro gap including a dynamic pressure generating groove is filled with a lubricant fluid. When the spindle motor rotates, a dynamic pressure generated in the thrust dynamic pressure bearing portion causes the rotating member to be floated with respect to the stationary member and to rotate in a non-contact state.

However, in a state in which the spindle motor is not rotated, no floating action is caused by a fluid dynamic pressure. Thus, bearing surfaces included in the thrust dynamic pressure bearing portion, which respectively correspond to the rotating member and the stationary member, may be surface-contacted with each other. When the spindle motor is activated or stopped, the bearing surfaces may be rubbed with each other, so that both the bearing surfaces may be scratched. When the spindle motor starts rotation, the circulation preventing action of a lubricant fluid is exerted because the distance of the gap between thrust bearing surfaces is small. Thus, it is difficult to quickly form a fluid layer and the rotating member cannot quickly be floated. Consequently, the function of the fluid dynamic bearing may be obstructed.

JP-A-2003-018792 (counterpart U.S. publication is: US 2002/0163268 A1) discloses a spindle motor configured so that a rotating body is supported by a stationary portion via a fluid dynamic bearing which supports both of a thrust load and a radial load, and that one of substantially flat surface portions facing each other at an axial end portion of the fluid dynamic bearing is provided with one or a plurality of protrusion portions manufactured separately from the one of the substantially flat surface portions so as to make the one or the plurality of protrusion portions abut against the other substantially flat surface portion during non-rotating state of the rotating body. JP-A-2003-018792 describes that with this configuration, the one or the plurality of protrusion portions abut against the opposed surface portion, that accordingly, a gap is formed between the substantially flat opposed end surface portions of the fluid dynamic bearing, that one of the opposed end surface portions is put into a state in which the one of the opposed end surface portions is floated with respect to the other end surface portion, and that a thrust bearing portion can be prevented from being brought into a substantially full-contact state.

JP-A-2002-327734 describes a configuration of a dynamic pressure bearing unit configured so that a thrust bearing gap is formed between a thrust bearing and one of end surfaces of an axial member opposed thereto, and that a protrusion portion is formed in the thrust bearing. JP-A-2002-327734 further describes that accordingly, when a thrust supporting force is decreased or vanished at activation or stoppage of the axial member thereby causing the axial member to fall and slide-contact with the thrust bearing, the slide-contact of the axial member with the thrust bearing is performed between the axial member and the protrusion portion formed in the thrust bearing. JP-A-2002-327734 further describes that consequently, the thrust bearing and a flange portion can be suppressed from being worn, and that the life of the bearing unit can be increased.

JP-A-2003-032959 discloses a spindle motor in which a thrust bearing portion is formed of a top surface of a sleeve and a bottom surface of a top plate of a rotor hub, and in which an annular protrusion portion is provided on one of the top surface of the sleeve and the bottom surface of the top plate of the rotor hub so as to make an axial gap dimension of a micro gap formed between the annular protrusion and the one of the top surface of the sleeve and the bottom surface of the top plate of the rotor smaller than that of the micro gap corresponding to the thrust bearing portion. JP-A-2003-032959 further describes the following advantages. That is, with this configuration, a portion at which the contact between the rotor hub and the sleeve occurs is limited only to a part at which an annular protrusion portion is formed, so that occurrence of the contact therebetween in the thrust bearing portion protected. The wear of the thrust bearing portion is suppressed. The durability and the reliability of the spindle motor can be enhanced.

When a spindle motor is formed by making each convex portion as a separate body and integrating one of substantially flat surface portions of the thrust bearing portion with the convex portion through press-fitting or the like, similarly to that described in JP-A-2003-018792, it is difficult to set an amount of protrusion of a plurality of convex portions from the one of substantially flat surface portions of the integrated component at a constant dimension with good accuracy. When the number of convex portions is small as one or two, both the substantially flat surface portions serving as the thrust bearing portion may be tilted and contacted with each other during non-rotating state of the spindle motor. Energy loss caused by starting the rotation of the spindle motor in such a condition is large. The wear of the thrust bearing surface cannot fully be prevented. In addition, the implementation of highly accurate rotations of the spindle is hindered. The manufacturing cost of the spindle motor is increased by adding steps for machining and press-fitting each separate convex portion to a manufacturing process thereby increasing the number of steps thereof.

The above mentioned publications, JP-A-2003-018792, JP-A-2002-327734, and JP-A-2003-032959, disclose a technical idea that the surface contact between the bearing-surfaces serving as the thrust bearing portion is prevented by making the protruding portion formed on one of the bearing surfaces abut against the other bearing surface. However, the contact between the protruding portion and the bearing surface is similar to point-contact or line-contact. Thus, at a contact portion, a contact pressure being higher than that due to the surface contact therebetween is generated. Accordingly, at the start of rotation of the spindle motor, the protrusion portion and the bearing surface slide with respect to each other under a high contact pressure. Thus, the thrust bearing surface cannot fully be prevented from being damaged.

According to the configurations proposed in the above mentioned publications, JP-A-2003-018792, JP-A-2002-327734, and JP-A-2003-032959, the protrusion portion is formed in the gap corresponding to the thrust bearing portion. The gap at a position, at which the protrusion portion is formed, is narrower than that at any other part in the thrust bearing portion. Consequently, at the start of rotation of the spindle motor, a bearing fluid is prevented from smoothly being circulated, so that energy loss is increased. It is difficult to quickly form a fluid layer. A rotating portion is floated neither quickly nor sufficiently largely. Accordingly, the functions of the fluid dynamic bearing are impaired.

### SUMMARY

One of objects of the present invention is to provide a fluid dynamic bearing that reliably prevents damage and wear of a fluid dynamic bearing and that is low in starting-torque due to smooth circulation of a bearing fluid and has a long lifetime, a spindle motor having the fluid dynamic bearing, and a storage apparatus having the spindle motor.

According to a first aspect of the invention, there is provided a fluid dynamic bearing including: a stationary shaft that includes: a first end portion being relatively fixed to a base plate; and a first radial bearing surface being defined on an outer circumferential surface of the stationary shaft; a radial bearing member that includes: a second radial bearing surface that faces the first radial bearing surface to have a first gap therebetween; and a first thrust bearing surface being defined on a first end portion of the radial bearing member, the radial bearing member being supported to be rotatable with respect to the stationary shaft; a thrust bearing member that is relatively fixed to the base plate and comprising a second thrust bearing surface that faces the first thrust bearing surface to have a second gap therebetween, the second gap communicating with the first gap; a lubricant fluid that fills the first gap and the second gap; a stopper portion that is provided on a second end portion of the stationary shaft and comprising a stopper surface; and a cover member that is fixed to a second end portion of the radial bearing member and comprising a central hole and an annular region that is defined around the central hole and faces the stopper surface. A distance L1 from the annular region of the cover member along a direction of an axis of rotation to the first thrust bearing surface of the radial bearing member, and a distance L2 from the stopper surface of the stopper portion to the second thrust bearing surface of the thrust bearing member, satisfy the following relationship: L1<L2. The annular region of the cover member is separated from the stopper surface of the stopper portion to form a gap when the radial bearing member relatively rotates with respect to the stationary shaft. The annular region of the cover member is in contact with the stopper surface of the stopper portion, and the first thrust bearing surface of the radial bearing member is separated from the second thrust bearing surface of the thrust bearing member to form a gap being filled with the lubricant fluid when the radial bearing member is in non-rotating state with respect to the stationary shaft.

According to a second aspect of the invention, there is provided a spindle motor including: a stationary shaft that includes: a first end portion being relatively fixed to a base plate; and a first radial bearing surface being defined on an outer circumferential surface of the stationary shaft; a radial bearing member that includes: a second radial bearing surface that faces the first radial bearing surface to have a first gap therebetween; and a first thrust bearing surface being defined on a first end portion of the radial bearing member, the radial bearing member being supported to be rotatable with respect to the stationary shaft; a thrust bearing member that is relatively fixed to the base plate and comprising a second thrust bearing surface that faces the first thrust bearing surface to have a second gap therebetween, the second gap communicating with the first gap; a lubricant fluid that fills the first gap and the second gap; a stopper portion that is provided on a second end portion of the stationary shaft and comprising a stopper surface; a cover member that is fixed to a second end portion of the radial bearing member and comprising a central hole and an annular region that is defined around the central hole and faces the stopper surface; and a motor device that rotates the radial bearing member. A distance L1 from the annular region of the cover member along a direction of an axis of rotation to the first thrust bearing surface of the radial bearing member, and a distance L2 from the stopper surface of the stopper portion to the second thrust bearing surface of the thrust bearing member, satisfy the following relationship: L1<L2. The annular region of the cover member is separated from the stopper surface of the stopper portion to form a gap when the radial bearing member relatively rotates with respect to the stationary shaft. The annular region of the cover member is in contact with the stopper surface of the stopper portion, and the first thrust bearing surface of the radial bearing member is separated from the second thrust bearing surface of the thrust bearing member to form a gap being filled with the lubricant fluid when the radial bearing member is in non-rotating state with respect to the stationary shaft.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a longitudinally cross-sectional view illustrating a cross-sectional structure of each of a fluid dynamic bearing according to first embodiment of the invention, a spindle motor having the fluid dynamic bearing, and a relevant part of a storage apparatus having the spindle motor.

FIGS. 2A and 2B are plan views illustrating an example of spiral dynamic pressure grooves provided on a thrust bearing surface of the fluid dynamic bearing.

FIG. 3 is a longitudinally cross-sectional view illustrating the relative positional relationship between a stopper surface and an inner bottom surface of a cover member in the fluid dynamic bearing during rotation thereof.

FIG. 4 is a longitudinally cross-sectional view illustrating the relative positional relationship between the stopper surface and the inner bottom surface of the cover member in the fluid dynamic bearing during non-rotating state thereof.

FIG. 5 is a longitudinally cross-sectional view illustrating a cross-sectional structure of each of a fluid dynamic bearing according to second embodiment of the invention, a spindle motor having the fluid dynamic bearing, and a relevant part of a storage apparatus having the spindle motor.

FIG. 6 is a longitudinally cross-sectional view illustrating a cross-sectional structure of characteristic portions of third embodiment of the invention.

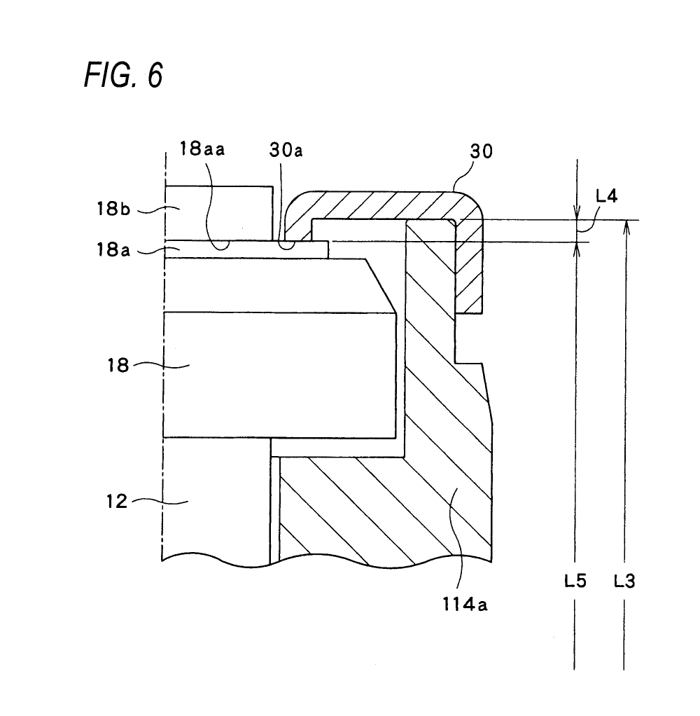

### DETAILED DESCRIPTION OF THE EMBODIMENTS

Hereinafter, embodiments of the invention will be described with reference to the drawings. In the following description, the sane or similar components will be denoted by the same reference numerals, and the duplicate description thereof will be omitted. The scope of the claimed invention should not be limited to the examples illustrated in the drawings and those described below.

### First Embodiment

A fluid dynamic bearing according to a first embodiment of the invention, and a spindle motor having the fluid dynamic bearing are described below.

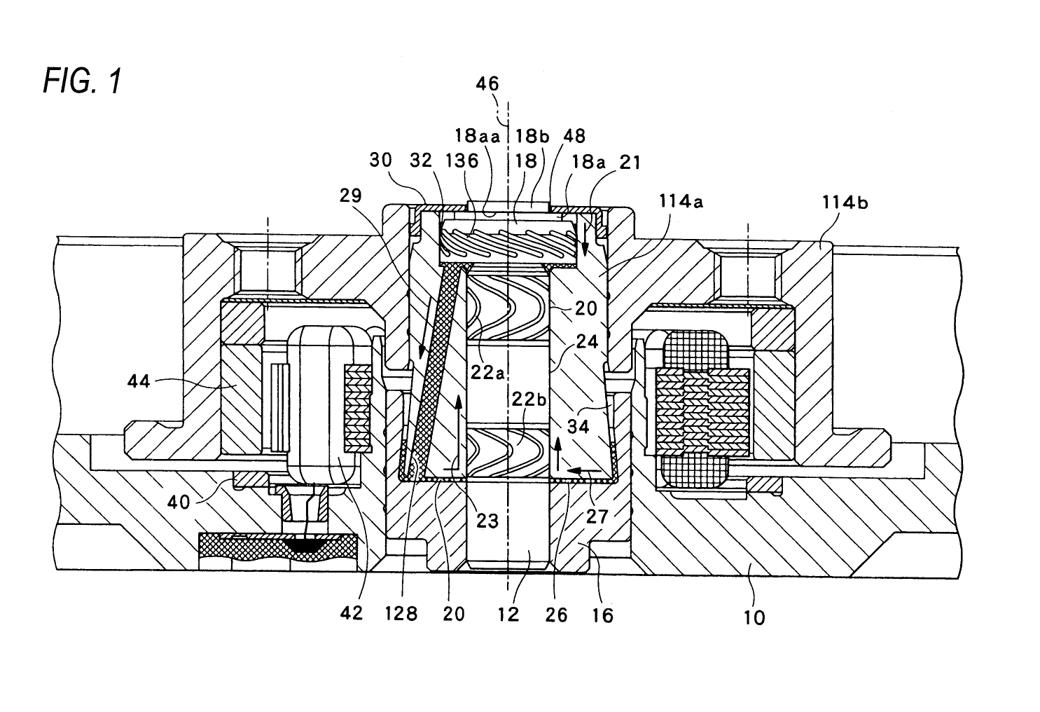

FIG. 1 illustrates a longitudinally cross-sectional structure of a relevant part of each of the fluid dynamic bearing according to first embodiment of the invention, and a spindle motor having the fluid dynamic bearing. The spindle motor is used in a storage apparatus for driving a recording disk.

The spindle motor includes a base plate 10 having a substantially cylindrical opening provided at the center thereof, in which a thrust bearing member 16 corresponding to a bushing is fit and accommodated.

The thrust bearing member 16 is substantially cup-shaped and includes a bottom portion, and an annular wall portion that extends upwardly and continuously from the bottom portion, as viewed in FIG. 1. A stationary shaft 12 is mounted in an opening surrounded by the annular wall portion.

A flange portion 18 formed annularly and integrally with the stationary shaft 12 is disposed at an upper end portion of the stationary shaft 12. The flange portion 18 includes a stopper portion 18a which is provided at an upper part thereof and has an annular stopper surface 18aa, and a front end portion 18b provided at a central part of an upper part of the stopper portion 18a.

The outer diameters DF of the flange portion 18, D1 of the annular stopper surface 18aa, and DS of the front end portion 18b have dimensions at which the following relationship is satisfied: DF≧D1>DS. A screw hole for connecting the spindle motor to a housing cover of a storage apparatus is opened in an end surface of the front end portion 18b of the stationary shaft 12, though the screw hole is not shown in the drawings.

A sleeve 114a is provided around the stationary shaft 12 by being inserted into the support hole to be rotatable with respect to the stationary shaft 12. A cup-shaped cover portion 30 having a central opened part, into which a front end part 18b of the flange portion 18 is inserted, is fixed onto the top portion of the sleeve 114a.

Incidentally, in order to accommodate the flange portion 18 of the stationary shaft 12, the diameter of the inner circumferential surface of an accommodating-part of the top portion of the sleeve 114a, in which the flange portion 18 is accommodated, is increased, while the diameter of the outer circumferential surface of a fitting-part of the top portion thereof, which is fit into the annular wall portion of the cover member 30, is reduced.

The inner end surface of the top portion of the sleeve 114a faces the bottom surface of the flange portion 18 of the stationary shaft 12 across a micro gap. The bottom surface of the sleeve 114a faces the inner bottom surface of the thrust bearing member 16 across a micro gap.

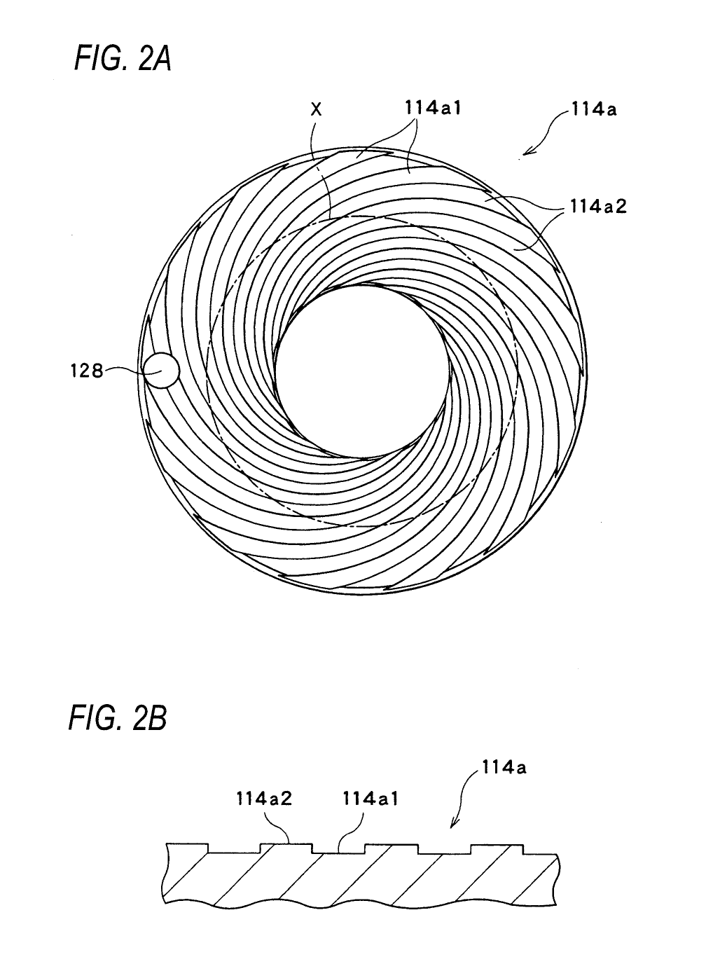

FIGS. 2a and 2B illustrate an example of a spiral dynamic pressure groove provided on the thrust bearing surface in the bottom surface of the sleeve 114a. FIG. 2A is a plan view illustrating the thrust bearing surface. FIG. 2B is a longitudinally cross-sectional view taken along a dot-dash-line shown in FIG. 2A, which illustrates a surface portion. As illustrated in FIGS. 2A and 2B, a plurality of grooves 114a1 and convex lands 114a2 can be provided alternately and spirally. However, the shape of the thrust bearing surface illustrated in FIGS. 2A and 2B is only illustrative. As long as the structure of the dynamic pressure grooves can generate a dynamic pressure, the thrust bearing surface can have other shapes.

Thus, the sleeve 114a is rotatably disposed in a space extending through the gap between the bottom surface of the flange portion 18 and the sleeve 114a and a space extending through the gap between the inner bottom surface of the thrust bearing member 16 and the sleeve 114a. A rotor hub 114b, on which a storage disk is loaded, is mounted on the upper outer circumferential surface of the sleeve 114a. According to first embodiment, the sleeve 114a and the rotor hub 114b serve as a radial bearing member.

The cover member 30 is fixed such that the inner bottom surface of the cover member 30 abuts against the outer end surface of the top portion of the sleeve 114a. Consequently, the cover member 30 is accurately positioned, so that a highly accurate relative positional relationship in the direction of an axis of rotation 46 between the bottom surface of the cover member 30 and the annular end surface, i.e., the stopper surface 18aa of the stopper portion 18a of the flange portion 18 is obtained.

The bottom portion of the thrust bearing member 16 includes a support hole into which the bottom portion of the stationary shaft 12 is fit. The bottom portion of the thrust bearing member 16 has thickness and stiffness required to surely fix the stationary shaft 12 thereto. The circumferential wall of the thrust bearing member 16 is fixed by fitting the outer circumferential surface thereof into the inner circumferential surface of a cylindrical portion provided on the base plate 10.

Adhesive agents can be applied between the stationary shaft 12 and the thrust bearing member 16 and between the thrust bearing member 16 and the base plate 10. In this case, it is preferable that the groove is provided on one of surfaces of a fit portion, because the adhesive agent is easily held in the fit portion.

In first embodiment, each of the stationary shaft 12, the sleeve 114a, the cover member 30, and the thrust bearing member 16 is configured by a single body. Thus, a single fluid dynamic bearing can be manufactured by preliminarily assembling these components. A spindle motor can be obtained by attaching the base plate 10 and the rotor hub 114b after that.

Micro gaps each of which is opened at both ends thereof are formed between the stationary shaft 12 and the sleeve 114a and between the sleeve 114a and the thrust bearing member 16, respectively. The micro gaps are continuously filled with lubricant fluids, e.g., ester oil.

A first capillary seal portion is formed at an upper opening end of the micro gap between the increased-diameter inner circumferential surface of the top portion of the sleeve 114a and the outer circumferential surface of the flange portion 18, which are opposed to each other, by a gap, whose width gradually increases towards the top thereof, as viewed in FIG. 1, in a tapered manner. An upper interface of the lubricant fluid is located in the first capillary seal portion.

A spiral groove 136 that performs the function of a pumping seal which pushes the lubricant fluid downwardly as indicated by arrow 21 is formed on the outer circumferential surface of the flange portion 18. The leak of the lubricant fluid from the upper opening end is reliably prevented by the composite action of two types of sealing functions and by the cover member 30.

The spiral groove 136 communicates with a seal gap 32, which preferably has a cross-sectional shape whose width gradually increases towards the top thereof, as viewed in FIG. 1, in a tapered manner, between the flange portion 18 and the sleeve 114a. The seal gap 32 extends in a direction substantially parallel to an axis of rotation 46 and is formed by two opposed surfaces, i.e., the outer circumferential surface of the flange portion and the increased-diameter inner circumferential surface of the sleeve 114a, which are relatively inclined to the axis of rotation 46, preferably inwardly inclined thereto, as viewed in FIG. 1. Consequently, the lubricant fluid is pushed in the direction of the bearing gap 20 illustrated in a lower part of FIG. 1 by a centrifugal force during the rotation of the fluid dynamic bearings.

A labyrinth seal 48 is formed in the gap between the cover member 30 and the end portion 18b of the stationary shaft 12. The replacement of air and the evaporation of the lubricant fluid caused along therewith are reduced. Consequently, the effect of preventing the lubricant fluid in the gap 32 from being leaked out of the bearing can be more surely enhanced.

A second capillary seal portion is formed at a lower opening end of the micro gap between the outer circumferential surface of the bottom portion of the sleeve 114a and the annular wall inner circumferential surface of the thrust bearing member 16 by a gap whose width gradually increases in a tapered manner towards the top thereof, as viewed in FIG. 1. In addition, a lubricant fluid retaining space 34 being continuous to the second capillary seal portion is formed. A lower interface of the lubricant fluid is located in the second capillary seal portion.

The lubricant fluid retaining space 34 includes a region that is broader than the bearing gap 20 and extends in a radial direction. This region is continuous with a tapered opening area which is formed by the outer circumferential surface of the sleeve 114a and the inner circumferential surface of the thrust bearing member 16 and extends substantially in the direction of the axis of rotation 46. The lubricant fluid retaining space 34 has the function of serving as a fluid reservoir portion in addition to the function of serving as a capillary seal. Thus, even when the lubricant fluid is lost by evaporation, the amount of fluid required for the bearing operational life is assured.

Usually, the leakage of the lubricant fluid at a lower opening end can be prevented by the second capillary seal portion. If the lubricant fluid goes beyond the second capillary seal portion, the lubricant fluid is accommodated in the lubricant retaining space 34. Accordingly, the leakage of the lubricant fluid is prevented. Additionally, a recirculation hole 128 to flow the lubricant fluid in an oblique direction indicated by arrow 29, which is outwardly inclined to the axis of rotation 46 from top to bottom, is provided between the micro gap at the top side of the sleeve 114a, i.e., the gap between the bottom surface of the flange portion 18 and the sleeve 114a, and the thrust bearing portion 26 at the bottom side of the sleeve 114a. Consequently, the lubricant fluid is smoothly circulated. Thus, even when air bubbles are generated in the lubricant fluid and are thermally expanded during the fluid dynamic pressure bearing operation, the air bubbles can be quickly eliminated to the outside from the gap 32 along a circulation path. Consequently, the bearing device according to the invention prevents the occurrence of a phenomenon that air bubbles expand thermally due to the rise of temperature and cause the lubricant fluid to leak out of the bearing.

The lubricant fluid retaining space 34 can compensate the variation of filling amount of the lubricant fluid. Both of the opposed surfaces of the sleeve 114a and the thrust bearing member 16, which form the tapered region of the lubricant fluid retaining space 34, are relatively and inwardly inclined to the axis of rotation 46. Consequently, the lubricant fluid is pushed towards the cross-sectional center in the direction of the bearing gap 20 by the centrifugal force during bearing rotation.

A first radial bearing portion 22a and a second radial bearing portion 22b spaced from each other in a direction along the axis of rotation 46 of the stationary shaft 12, as viewed in FIG. 1, are configured between the outer circumferential surface of the stationary shaft 12 and the inner circumferential surface of the sleeve 114a corresponding to the radial bearing member according to first embodiment of the invention to generate a radial dynamic pressure.

More specifically, two radial bearing surfaces of the sleeve 114a separated from each other in the axial direction by a circumferential groove 24 disposed in the vicinity of the center of the inner circumferential surface of the sleeve 114a along the direction of the axis of rotation 46 of the stationary shaft 12, surround the stationary shaft 12 and have appropriate dynamic pressure groove structures, while the bearing gap 20 having a gap-distance of few microns is formed.

Consequently, the first radial bearing portion 22a and the second radial bearing portion 22b separated from each other along the axis of rotation 46 of the stationary shaft 12 are configured.

The radial dynamic pressure groove structure can be formed on the radial bearing surface of the sleeve 114a. Alternatively, the radial dynamic pressure groove structure can be formed on the radial bearing surface of the stationary shaft 12.

Each of the dynamic pressure groove structures respectively formed on the first radial bearing portion 22a and the second radial bearing portion 22b includes a plurality of dynamic pressure grooves having a half-sinusoidal-waveform to send out the lubricant fluid to upward or downward direction along the axis of rotation 46.

A thrust bearing surface of the sleeve 114a extending in a radial direction and a corresponding thrust bearing surface of the thrust bearing member 16, which is opposed to the thrust bearing surface of the sleeve 114a, are formed at the lower side of the second radial bearing portion 22b, as viewed in FIG. 1. A region of the bearing gap 20 extending in a radial direction is provided between the thrust bearing surfaces. These thrust bearing surfaces serve as a thrust bearing portion 26 having an annular bearing surface perpendicular to the axis of rotation 46 of the stationary shaft 12.

In the thrust bearing portion 26, a spiral dynamic groove structure that sends out the lubricant fluid towards the center of the axis of rotation 46 indicated by arrow to generate a dynamic pressure acting in a thrust direction is formed on the thrust bearing surface of the sleeve 114a, the thrust bearing surface of the thrust bearing member 16, or each of both the thrust bearing surfaces of the sleeve 114a and the thrust bearing member 16. The spiral dynamic pressure groove structure can be provided on a partial region of the thrust bearing surface of the sleeve 114a. However, in order to generate a dynamic pressure over the entire region of the thrust bearing surface, it is desirable to form the dynamic pressure structure that extend over the entire region of the thrust bearing surface, i.e., from the inner edge portion to the outer edge portion thereof.

According to this dynamic pressure structure, a positive pressure distribution is obtained over the entire bearing gap 20 of the thrust bearing portion 26, so that occurrence of a region of negative pressure can be prevented. This is due to the fact that the fluid pressure continuously decreases from a radially inner position of the thrust bearing portion 26 to a radially outer position thereof. Thus, even when gas is generated in the lubricant fluid, the gas is led towards the radially outer side according to a pressure gradient that decreases towards the radially outer side of the bearing. The gas is discharged from the thrust bearing portion 26 towards the lubricant fluid retaining space 34.

In the description of first embodiment of the invention, a thrust bearing portion 26 having the spiral dynamic pressure groove structure was described. However, the dynamic pressure groove shape is not limited to the spiral shape as long as the groove shape is suitable to generate a dynamic pressure,.

An electromagnetic driving device(motor device) of the spindle motor includes a stator structure 42 disposed in a cylindrical portion of the base plate 10, and an annular permanent magnet 44 that is disposed on the inner circumferential surface of the rotor hub 114b and surrounds the stator structure 42 via a gap. When electric current is applied to the coil of the stator structure 42, a rotor portion including the rotor hub 114b and the sleeve 114a rotates. Consequently, a dynamic pressure is generated in the first radial bearing portion 22a, the second radial bearing portion 22b, and the thrust bearing portion 26. The rotor portion is floated and rotates while the rotor portion is supported in a non-contact state.

The spindle motor has only the thrust bearing portion 26 which generates a force for floating the rotor portion upwardly in the axial direction by a fluid dynamic pressure and does not have a bearing portion that generates a downward force.

Thus, it is preferable to impart a proper reaction force and an initial load on the rotor portion to thereby equalize upward and downward forces in the axial direction. In first embodiment of the invention, a ferromagnetic ring which faces the permanent magnet 44 in the axial direction and is magnetically attracted by the permanent magnet 44 is provided on the base plate 10. A magnetic attractive force thereof acts downwardly, i.e., in a direction opposite to the upward force due to the fluid dynamic pressure generated in the thrust bearing portion 26. Consequently, the forces acting in the axial direction can be balanced. Thus, the rotor can be prevented from being overfloated, and the rotor portion can be held stably.

While the rotor portion stably rotates, a micro gap is formed between the inner bottom surface of the cover member 30 and the stopper surface 18aa of the stopper portion 18a. This micro gap is set to be smaller than the axial gap 20 formed in the thrust bearing portion 26. When the rotation of the spindle motor is stopped, the floating force due to a dynamic pressure supporting the rotor portion stops to act. The rotor portion comes down so that the inner bottom surface of the cover member 30 abuts against the stopper surface 18aa which is the top surface of the stopper portion 18a.

However, in the thrust bearing portion 26, the thrust bearing surfaces of the sleeve 114a and the thrust bearing member 16, which face each other, are not in contact with each other, so that the micro bearing gap 20 is left. Consequently, the thrust bearing surfaces can surely be prevented from being scratched and worn by the contact therebetween. Even when subjected to impact, the thrust bearing surfaces opposed to each other are not in contact with each other in the thrust bearing portion 26, so that the micro bearing gap 20 is assured. Thus, damage to the thrust bearing surfaces can be prevented.

According to the first embodiment, no convex portion or the like is provided on the thrust bearing surface of the thrust bearing portion 26. Consequently, local reduction of the distance of the micro bearing gap 20 in the thrust bearing portion 26 is not caused. Accordingly, at rotation start or the like, smooth circulation of the lubricant fluid is performed in the thrust bearing portion 26. A fluid layer is quickly formed. Thus, the thrust bearing surfaces can be prevented from being scratched and worn by the contact therebetween.

Hereinafter, a structure for preventing damage to the bearing by improving the circulation of the lubricant fluid at the start-up of the spindle motor according to the first embodiment is described in detail.

As described above, the stopper portion 18a having the stepped stopper surface 18aa is provided on the top surface of the flange portion 18 of the stationary shaft 12.

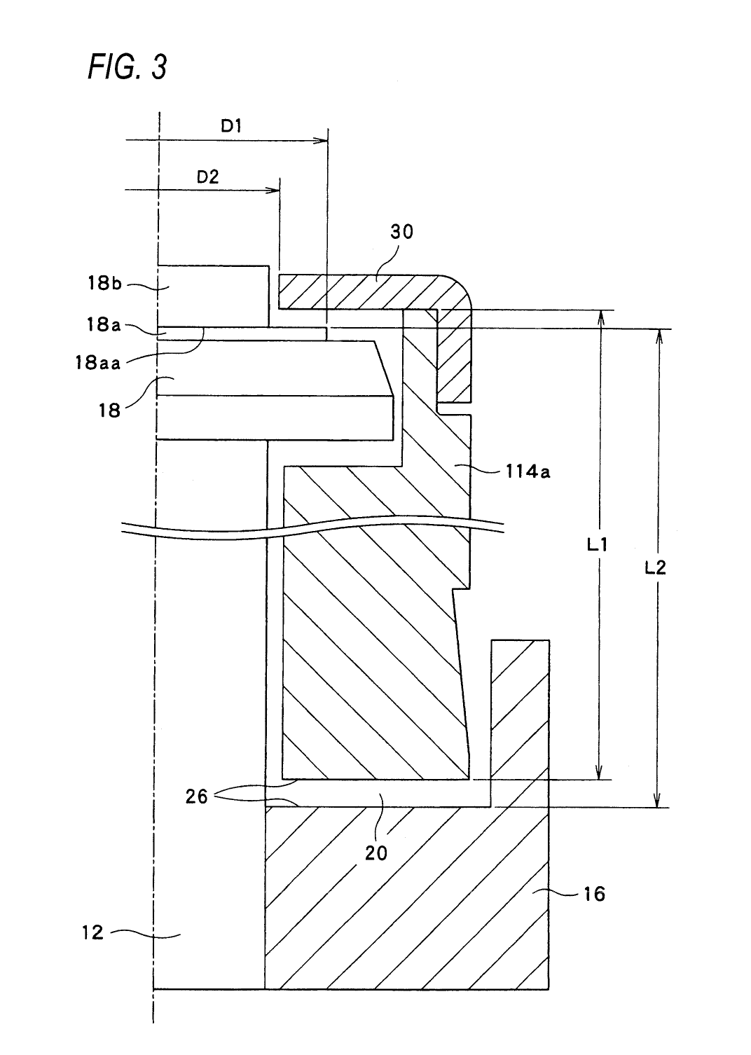

FIG. 3 illustrates the relative positional relationship between the stopper surface 18aa of the stopper portion 18a of the flange portion 18 during rotation of the spindle motor, and the cover member 30.

Between the outer diameter D1 of the stopper surface 18aa and the inner diameter D2 of a hole of the cover member 30, the following relationship holds: D1>D2. The difference (D1−D2) between the outer diameter D1 and the inner diameter D2 corresponds to the width dimension of a ring-like region in which the inner bottom surface of the cover member 30 and the stopper surface 18aa of the stopper portion 18a can be in contact with each other.

Between the distance L1 from the inner bottom surface of the cover member 30 to the bottom surface of the sleeve 114a and the distance L2 from the stopper surface 18aa of the stopper portion 18a to the inner top surface of the thrust bearing member 16, the following relationship holds: L2>L1. Thus, in a condition where the stopper surface 18aa of the stopper portion 18a abuts against the inner bottom surface of the cover member 30, the bearing gap 20 is present between the bottom surface of the sleeve 114a and the inner top surface of the thrust bearing member 16, i.e., between the thrust bearing surfaces in the thrust bearing portion 26.

During rotation of the spindle motor, the gap is present between the inner bottom surface of the cover member 30 and the stopper surface 18aa of the stopper portion 18a. In addition, the bearing gap 20 is present between the bottom surface of the sleeve 114a and the inner top surface of the thrust bearing member 16.

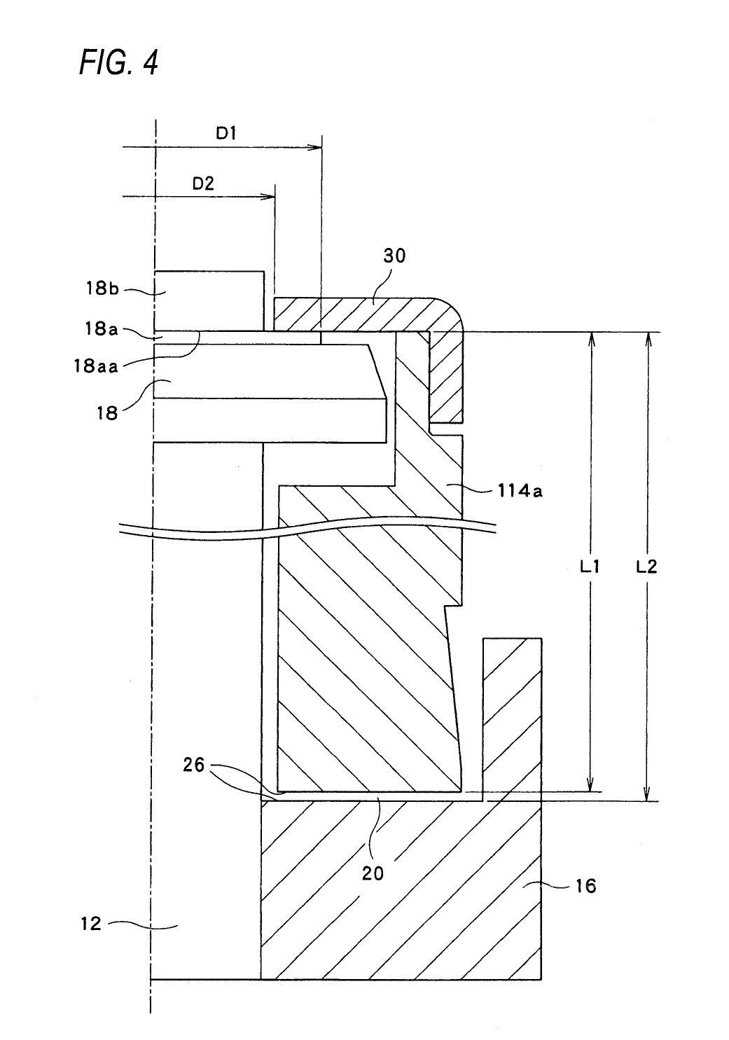

FIG. 4 illustrates the relative positional relationship between the stopper portion 18a of the flange portion 18 and the cover member 30 during non-rotating state of the spindle motor.

When the rotation of the spindle motor is stopped, as described above, the floating force due to the dynamic pressure for supporting the rotor portion does not act. The rotor portion comes down so that the inner bottom surface of the cover member 30 abuts against the stopper surface 18aa of the stopper portion 18a. In this state, the thrust bearing surfaces in the thrust bearing portion 26 are not in contact with each other. The bearing gap 20 is assured therebetween. Also, the lubricant fluid is present therebetween.

When the spindle motor starts rotation from a non-rotating state, the lubricant fluid present in the bearing gap 20 is quickly circulated. Thus, the stable positional relationship illustrated in FIG. 3 is quickly achieved. A place on which the cover member 30 and the stopper portion 18a are in contact with each other is limited only to an abutment surface on which the inner bottom surface of the cover member 30 and the stopper surface 18aa of the stopper portion 18a abut against each other. This abutment surface is a ring-like region having a width dimension of (D1−D2). The area of the abutment surface can be set to be very small, as compared with that of each thrust bearing surface. The contact between the cover member 30 and the stopper portion 18a is a surface contact differing from a very localized contact, such as the contact between convex portions. Thus, substantially no parts of the cover member 30 and the stopper portion 18a are worn. Damage to the thrust bearing surfaces is avoided. In addition, the torque can be reduced considerably.

Even when the fluid dynamic bearing is subjected to axial impact, the inner bottom surface of the cover member 30 and the stopper surface 18aa of the stopper portion 18a abut against each other, so that the contact between the thrust bearing surfaces can be avoided. Thus, damage to the bearing can be prevented. In addition, there is no need for performing wear resistant treatment on the opposed thrust bearing surfaces. This configuration contributes to reduction of the cost.

The stopper portion 18a can be easily produced when processing the stationary shaft 12 by stepping the top surface of the flange portion 18 and forming the stationary shaft 12 and the flange portion 18 as a single body. Thus, the dimensions of and the positional relationship among the components of the bearing can be implemented with high accuracy at low cost, differently from the case of press-fitting a separate component into the thrust bearing surface to make the convex portion. Moreover, when a wear resistant treatment is performed on the stationary shaft 12, the treatment can be also performed on the stopper surface 18aa of the stopper portion 18a simultaneously, because the stopper portion 18 and the stationary shaft 12 are formed as a single body. Consequently, the bearing can be manufactured at low cost without increasing the number of operations and manufacturing time.

### Second Embodiment

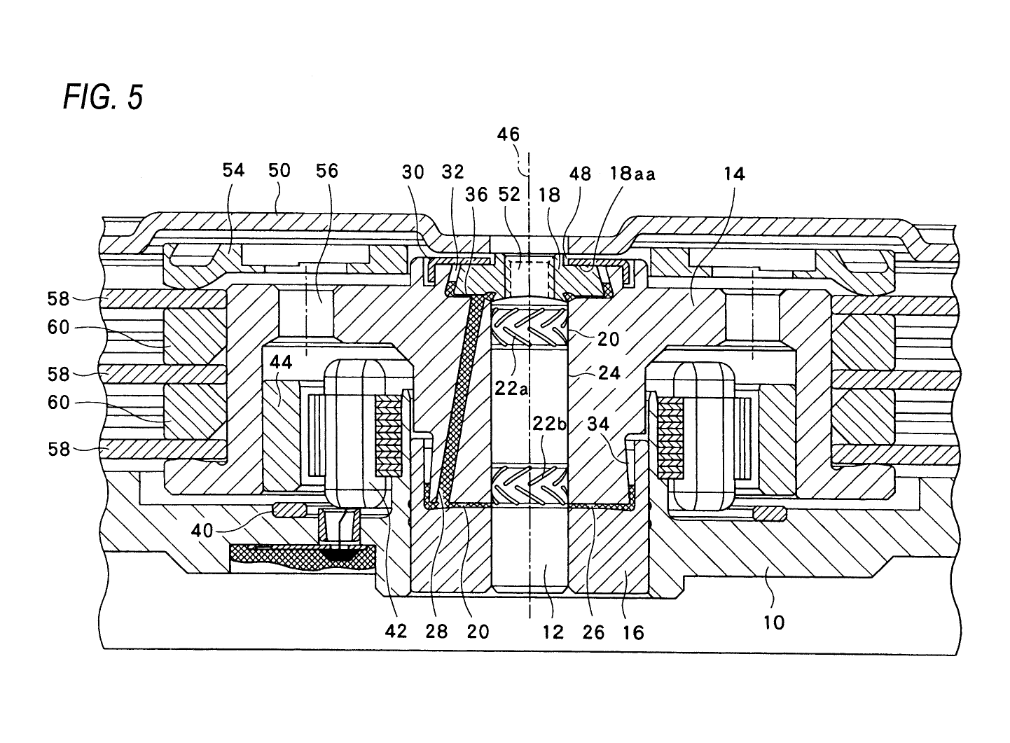

A spindle motor having a fluid dynamic bearing according to a second embodiment of the invention, and a storage apparatus having this spindle motor are described below with reference to FIG. 5 that illustrates a longitudinal cross-sectional structure. Hereinafter, components of the fluid dynamic bearing according to the second embodiment, which are equivalent to or substantially equivalent in function to those of the bearing according to the first embodiment, are designated with the same reference numbers as those used in the first embodiment.

According to the second embodiment, a sleeve and a hub are formed as a single body and serve as a rotor portion 14. Thus, the second embodiment may not be configured as an independent fluid dynamic bearing. Instead, the fluid dynamic bearing according to the second embodiment is configured as a spindle motor integrated with the bearing, or a storage apparatus having this spindle motor.

A recording disk 58 to be used in the storage apparatus is mounted on a cup-shaped outer part of the rotor portion 14. A plurality of annular storage disks 58 are mounted in the rotor portion 14 separated from one another by a spacer 60. The storage disk 58 is retained by a clamping portion 54 that can be screwed into a screw hole 56 of the rotor portion 14. The top surface of the storage apparatus is covered with a housing cover 50.

The bearing according to the first embodiment includes a stopper portion 18a provided with a stopper surface 18aa formed by stepping the top surface of the flange portion 18 of the stationary shaft 12 provided with a screw hole 52 bored in a central part of the top surface thereof. On the other hand, according to the second embodiment, an upper end surface in a circumferential region of the flange portion 18 of the stationary shaft 12 is used directly as the stopper surface 18aa.

The stopper surface 18aa abuts against the inner bottom surface of the cover member 30 fixed to the rotor portion 14. Thus, thrust bearing surfaces can be prevented from being in contact with each other in a thrust bearing portion 26.

Thus, as long as the end surface acting as the stopper surface 18aa can abut against the cover member 30 fixed to the rotor portion 14 and can prevent the thrust bearing surfaces from being in contact with each other in the thrust bearing portion 26, the position of the end surface acting as the stopper surface 18aa is not limited to a specific position.

The radial bearing member of the fluid dynamic bearing according to the second embodiment differs from that of the first embodiment and is configured as the rotor portion 14 obtained by integrating the sleeve with the rotor hub as a single body. According to the invention, the radial bearing member can be configured by the sleeve and the rotor hub that are separate single components. Alternatively, the radial bearing member can be configured as a single component obtained by integrating the sleeve with the rotor hub.

### Third Embodiment

A fluid dynamic bearing according to a third embodiment of the invention, a spindle motor having this fluid dynamic bearing, and a storage apparatus having this spindle motor are described below with reference to FIG. that illustrates a longitudinal cross-sectional structure of characteristic portions thereof.

According to the third embodiment, an abutment surface 30a can be configured by inwardly folding the rim of the central hole of the bottom portion of the cover member 30 according to the first embodiment so that the abutment surface 30a abuts against the stopper surface 18aa of the stopper portion 18a provided on the top surface of the flange portion 18. In other words, the abutment surface 30a corresponds to the end surface of the circumferential wall formed along the circumference of the cover member central hole.

The distance between the abutment surface 30a and the inner bottom surface of the cover member 30 has a dimension L4. Between a sum (L5+L4) of the dimension L4 from the inner bottom surface of the cover member 30 and the distance L5 from the inner top surface of the thrust bearing member 16 to the stopper surface 18aa of the stopper portion 18a, and the distance L3 from the inner bottom surface of the cover member 30 to the bottom surface of the sleeve 114a, the following relationship holds: (L5+L4)>L3. Consequently, in a state in which the abutment surface 30a of the cover member 30 abuts against the stopper surface 18aa of the stopper portion 18a, the bearing gap 20 is present between the bottom surface of the sleeve 114a and the inner top surface of the thrust bearing member 16, i.e., between the thrust bearing surfaces in the thrust bearing portion 26. Thus, similarly to the first embodiment, in the non-rotating state, thrust bearing surfaces in the thrust bearing portion 26 are not in contact with each other. The bearing gap 20 is assured between the thrust bearing surfaces. The lubricant fluid is present in the bearing gap 20. When the spindle motor starts to rotate, the lubricant fluid is quickly circulated. Consequently, damage to the thrust bearing surfaces is prevented and starting-torque can be considerably reduced. Also, even when the spindle motor stops rotation thereof, damage to the thrust bearing surfaces can be prevented.

Similarly, the bearing can be configured by inwardly folding the rim of a central hole of the bottom portion of the cover member 30 according to the above second embodiment so that the abutment surface abuts against the stopper surface 18aa in a peripheral region of the flange portion 18.

In any of the above cases, it is preferable that wear resistant treatment is applied on the contact part of at least one of the cover member and the stopper surface. Consequently, the abrasion between the cover member and the stopper surface can be reduced.

For example, a treatment of increasing surface hardness by forming a hard coating, or a treatment of reducing friction coefficient by forming a solid lubricant coating can be used as the wear resistant treatment.

A coating made of DLC, TiN, TiCN, Al₂O₃ or the like, which is high in hardness and low in friction coefficient, can be used as the hard coating. Solid lubricant agents using polytetrafluoroethylene (PTFE), molybdenum disulfide (MoS₂), black lead, boron nitride (BN) or the like can be used as the solid lubricants. However, the wear resistant treatment, the hard coating, and the solid lubricant are not limited to those mentioned above.

As described with reference to the embodiments, there is provided a fluid dynamic bearing, a spindle motor having the fluid dynamic bearing, and a storage apparatus having the spindle motor, which has the following advantages. That is, during non-rotating state of the bearing apparatus, a stopper portion and a cover member, which are portions other than the thrust bearing portion, abut against each other. The thrust bearing surfaces are not in contact with each other, so that the gap is assured. Lubricant fluid is continuously present in the gap. There is no place locally narrowed in the gap between the thrust bearing surfaces. Thus, when the spindle motor is started, the circulation of the lubricant fluid is smoothly and quickly performed without contact between the thrust bearing surfaces. The thrust bearing can quickly reach a stable floating position. In addition, when the spindle motor is stopped, the thrust bearing surfaces are not in contact with each other. Accordingly, the starting-torque is reduced. The thrust bearing surfaces are not damaged. The wear of the thrust bearing surfaces can surely be prevented.

In addition, the lubricant fluid can be prevented from being contaminated with abrasion powder. There is no possibility of occurrence of wear of the thrust bearing surfaces. Accordingly, it is unnecessary to perform wear resistant treatment, such as diamond-like carbon (DLC) coating, on the thrust bearing surface. Thus, the cost of the thrust bearing is reduced. In addition, even when the thrust bearing is subjected to axial impact, the thrust bearing surfaces are not in contact with each other. Consequently, the thrust bearing surfaces are protected. The durability and the reliability thereof are enhanced.

Although the embodiments according to the present invention have been described above, the present invention is not limited to the above-mentioned embodiments but can be variously modified. Constituent components disclosed in the aforementioned embodiments may be combined suitably to form various modifications. For example, some of all constituent components disclosed in the embodiments may be removed, replaced, or maybe appropriately combined with other components.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fluid dynamic bearing comprising:
a stationary shaft that comprises: a first end portion being relatively fixed to a base plate; and a first radial bearing surface being defined on an outer circumferential surface of the stationary shaft;
a radial bearing member that comprises: a second radial bearing surface that faces the first radial bearing surface to have a first gap therebetween; and a first thrust bearing surface being defined on a first end portion of the radial bearing member, the radial bearing member being supported to be rotatable with respect to the stationary shaft;
a thrust bearing member that is relatively fixed to the base plate and comprising a second thrust bearing surface that faces the first thrust bearing surface to have a second gap therebetween, the second gap communicating with the first gap;
a lubricant fluid that fills the first gap and the second gap;
a stopper portion that is provided on a second end portion of the stationary shaft and comprising a stopper surface; and
a cover member that is fixed to a second end portion of the radial bearing member and comprising a central hole and an annular region that is defined around the central hole and faces the stopper surface,
wherein a distance L1 from the annular region of the cover member along a direction of an axis of rotation to the first thrust bearing surface of the radial bearing member, and a distance L2 from the stopper surface of the stopper portion to the second thrust bearing surface of the thrust bearing member, satisfy the following relationship: L1<L2,
wherein the annular region of the cover member is separated from the stopper surface of the stopper portion to form a gap when the radial bearing member relatively rotates with respect to the stationary shaft, and
wherein the annular region of the cover member is in contact with the stopper surface of the stopper portion, and the first thrust bearing surface of the radial bearing member is separated from the second thrust bearing surface of the thrust bearing member to form a gap being filled with the lubricant fluid when the radial bearing member is in non-rotating state with respect to the stationary shaft.

2. The fluid dynamic bearing according to claim 1,
wherein the stopper surface of the stopper portion has an outer diameter of D1 and the central hole of the cover member has an inner diameter of D2, and
wherein the annular region of the cover member is defined within an area between the outer diameter D1 and the inner diameter D2.

3. The fluid dynamic bearing according to claim 1,
wherein the cover member comprises a circumferential wall formed along a circumference of the central hole, and
wherein an end surface of the circumferential wall is defined as the annular region.

4. The fluid dynamic bearing according to claim 1,
wherein a wear resistant treatment is performed on at least one of the stopper surface and the annular region of said cover member.

5. The fluid dynamic bearing according to claim 1,
wherein the first end portion of the stationary shaft is fixed to the base plate via the thrust bearing member.

6. A spindle motor comprising:
a stationary shaft that comprises: a first end portion being relatively fixed to a base plate; and a first radial bearing surface being defined on an outer circumferential surface of the stationary shaft;
a radial bearing member that comprises: a second radial bearing surface that faces the first radial bearing surface to have a first gap therebetween; and a first thrust bearing surface being defined on a first end portion of the radial bearing member, the radial bearing member being supported to be rotatable with respect to the stationary shaft;
a thrust bearing member that is relatively fixed to the base plate and comprising a second thrust bearing surface that faces the first thrust bearing surface to have a second gap therebetween, the second gap communicating with the first gap;
a lubricant fluid that fills the first gap and the second gap;
a stopper portion that is provided on a second end portion of the stationary shaft and comprising a stopper surface;
a cover member that is fixed to a second end portion of the radial bearing member and comprising a central hole and an annular region that is defined around the central hole and faces the stopper surface; and
a motor device that rotates the radial bearing member,
wherein a distance L1 from the annular region of the cover member along a direction of an axis of rotation to the first thrust bearing surface of the radial bearing member, and a distance L2 from the stopper surface of the stopper portion to the second thrust bearing surface of the thrust bearing member, satisfy the following relationship: L1<L2,
wherein the annular region of the cover member is separated from the stopper surface of the stopper portion to form a gap when the radial bearing member relatively rotates with respect to the stationary shaft, and
wherein the annular region of the cover member is in contact with the stopper surface of the stopper portion, and the first thrust bearing surface of the radial bearing member is separated from the second thrust bearing surface of the thrust bearing member to form a gap being filled with the lubricant fluid when the radial bearing member is in non-rotating state with respect to the stationary shaft.

7. The spindle motor according to claim 6,
wherein the stopper surface of the stopper portion has an outer diameter of D1 and the central hole of the cover member has an inner diameter of D2, and
wherein the annular region of the cover member is defined within an area between the outer diameter D1 and the inner diameter D2.

8. The spindle motor according to claim 6,
wherein the cover member comprises a circumferential wall formed along a circumference of the central hole, and
wherein an end surface of the circumferential wall is defined as the annular region.

9. The spindle motor according to claim 6,
wherein a wear resistant treatment is performed on at least one of the stopper surface and the annular region of said cover member.

10. The spindle motor according to claim 6,
wherein the first end portion of the stationary shaft is fixed to the base plate via the thrust bearing member.

11. A storage apparatus comprising:
the spindle motor according to claim 6; and
a recording disk mounted on the radial bearing member to be rotated by the motor device of the spindle motor.
